(19) United States
(12) Patent Application Publication
(10) Pub. No.: US 2010/0149116 A1
(43) Pub. Date: Jun. 17, 2010

(54) TOUCH DEVICE AND TOUCH DISPLAY PANEL

(76) Inventors: Tun-Chun Yang, Hsin-Chu (TW); Seok-Lyul Lee, Hsin-Chu (TW); Wei-Ming Huang, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/434,681

(22) Filed: May 3, 2009

(30) Foreign Application Priority Data
Dec. 11, 2008 (TW) 097148203

(51) Int. Cl. G06F 3/041; G02F 1/1333

(52) U.S. Cl. 345/173; 349/110

(57) ABSTRACT

A touch device includes a patterned sensing electrode structure, an insulating layer and a patterned common electrode layer. The patterned sensing electrode structure is disposed on a surface of a substrate, defining a plurality of displaying regions and a light-shielding region. The patterned sensing electrode structure corresponds to the light-shielding region, and exposes the displaying regions. The insulating layer covers the patterned sensing electrode structure. The patterned common electrode layer is disposed on the insulating layer, and the patterned common electrode layer includes a plurality of electrode portions corresponding to the displaying regions and a plurality of connecting portions disposed between the adjacent electrode portions and electrically connected to the electrode portions.

### BACKGROUND OF THE INVENTION

1. Field of the Invention

The present invention relates to a touch device and a touch display panel.

2. Description of the Prior Art

LCD (liquid crystal display) is one type of flat display, popular on the market for its characteristics of power saving, thinness, and light weight. In any kind of electronic device that includes an LCD, such as a media player, mobile phone or personal digital assistant (PDA), a touch input function of the LCD is becoming more popular, with the result that touch panels are now in widespread use.

Conventional touch display panels are mainly classified into resistance-type touch display panels and capacitor-type touch display panels. The resistance-type touch display panel tracks the contact position through a voltage difference or a voltage variation. The capacitor-type touch display panel usually includes sensing capacitors, and tracks the contact position through the capacitance variation of the sensing capacitor located at the contact position. The conventional touch display panels are manufactured by individually manufacturing a touch panel and a liquid crystal panel and assembling the touch panel and the liquid crystal display panel together. For this reason, there are shortcomings in the conventional touch display panels, such as heavy weight, high cost and low transmittance etc. In order to improve the shortcomings, a touch device and a display device that are manufactured in a same display panel has recently been developed, and a liquid crystal panel with the touch input function can thereby be formed. The touch device of the conventional touch display panel is generally disposed between a substrate and the display device, so that sensing pads in the touch device and a common electrode on a color filter substrate of the liquid crystal panel form a coupling capacitor. Therefore, the sensing pads are affected by the coupling capacitor when a finger touches the conventional touch display panel, and a problem of insufficient intensity of the sensing signal occurs.

### SUMMARY OF THE INVENTION

It is therefore an objective of the present invention to provide a touch device and a touch display panel so as to reduce a coupling capacitance between a sensing electrode and a common electrode to increase intensity of a sensing signal.

According to an embodiment of the present invention, a touch device formed on a surface of a substrate is provided. The surface of the substrate defines a plurality of sensing regions arranged as a matrix formation, and each sensing region defines a plurality of displaying regions arranged as a matrix formation, and a light-shielding region disposed between the displaying regions. The touch device comprises a patterned sensing electrode structure, a first insulating layer and a patterned common electrode layer. The patterned sensing electrode structure is disposed on the surface of the substrate, and the patterned sensing electrode structure corresponds to the light-shielding region and exposes the displaying regions. The first insulating layer covers the substrate and the patterned sensing electrode structure. The patterned common electrode layer is disposed on the first insulating layer, and the patterned common electrode layer comprises a plurality of electrode portions corresponding to the displaying regions, and a plurality of connecting portions. The connecting portions are respectively disposed between the adjacent electrode portions and over the light-shielding region. The connecting portions are electrically connected to the electrode portions.

According to the claimed invention, a touch display panel is provided. The touch display panel comprises a first substrate, a second substrate, a liquid crystal layer, a patterned sensing electrode structure, an insulating layer, and a patterned common electrode layer. The first substrate and the second substrate are parallel to each other, and the first substrate has a surface facing the second substrate. The surface of the first substrate defines a plurality of sensing regions, and each sensing region defines a plurality of displaying regions arranged as a matrix formation, and a light-shielding region disposed between the displaying regions. The liquid crystal layer is disposed between the first substrate and the second substrate. The patterned sensing electrode structure is disposed on the surface of the first substrate, and the patterned sensing electrode structure corresponds to the light-shielding region and exposes the displaying regions. The first insulating layer covers the surface of the first substrate and the patterned sensing electrode structure. The patterned common electrode layer is disposed on the first insulating layer, and the patterned common electrode layer comprises a plurality of electrode portions corresponding to the displaying regions, and a plurality of connecting portions. The connecting portions are respectively disposed between the adjacent electrode portions and electrically connected to the electrode portions.

The present invention provides the patterned sensing electrode structure corresponding to the light-shielding region combined with the electrode portions of the patterned common electrode layer, and reduces the area of the connecting portions, so that the overlap between the patterned sensing electrode structure and the patterned common electrode layer can be reduced. The coupling capacitance between the patterned sensing electrode structure and the patterned common electrode layer can therefore be reduced, and the intensity of the sensing signal sensed from the patterned sensing electrode structure can be increased accordingly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a cross-sectional structure of a touch display panel according to a first preferred embodiment of the present invention.

FIG. 2 is a schematic diagram illustrating a structure of the touch display panel according to the first preferred embodiment of the present invention.

FIG. 3 is a schematic diagram illustrating a top-view of the patterned sensing electrode structure of the present invention.

FIG. 4 is a schematic diagram illustrating a cross-sectional structure of a touch device according to a second preferred embodiment of the present invention.

FIG. 5 is a schematic diagram illustrating a structure of the touch device according to the second preferred embodiment of the present invention.

FIG. 6 is a schematic diagram illustrating a cross-sectional structure of a touch device according to a third preferred embodiment of the present invention.

FIG. 7 is a schematic diagram illustrating a structure of the touch device according to the third preferred embodiment of the present invention.

### DETAILED DESCRIPTION

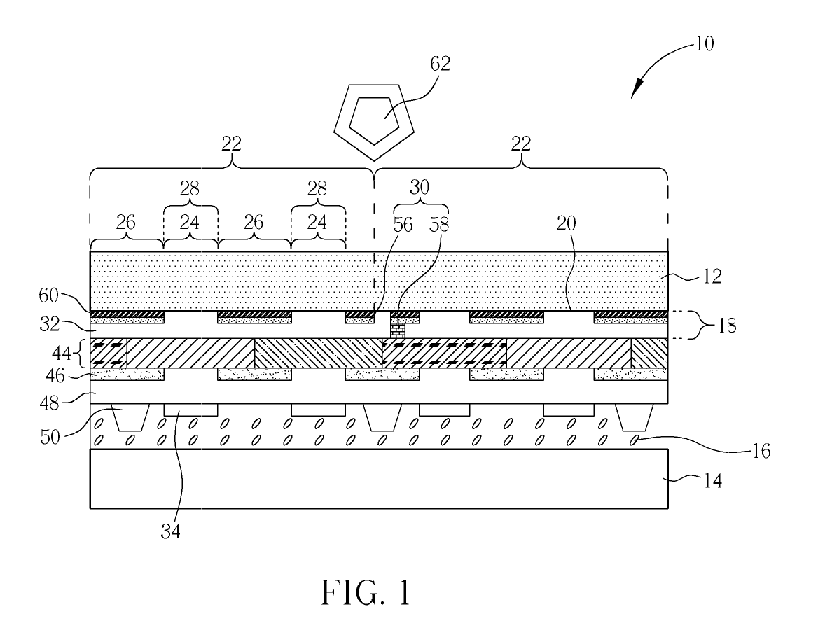

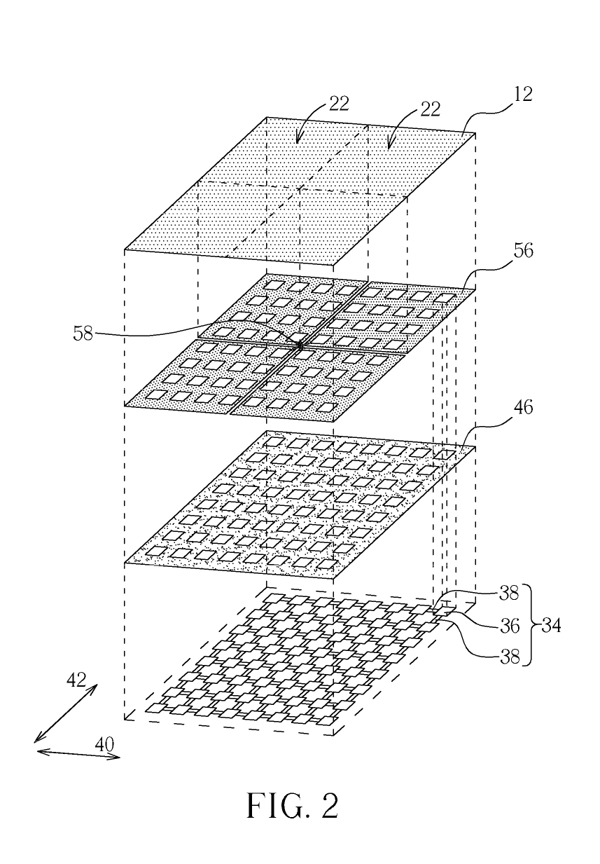

Referring to FIG. 1 and FIG. 2, FIG. 1 is a schematic diagram illustrating a cross-sectional structure of a touch display panel according to a first preferred embodiment of the present invention, and FIG. 2 is a schematic diagram illustrating the touch display panel according to the first preferred embodiment of the present invention. As shown in FIG. 1 and FIG. 2, the touch panel 10 includes a first substrate 12, a second substrate 14, a liquid crystal layer 16, and a touch device 18. The first substrate 12 and the second substrate 14 are parallel to each other, and the first substrate 12 has a surface 20 facing the second substrate 14. The surface 20 of the substrate 12 defines a plurality of sensing regions 22, and each sensing region 22 defines a plurality of displaying regions 24 arranged as a matrix formation and a light-shielding region 26 disposed between the displaying regions 24. The first substrate 12 can be a transparent substrate, such as glass substrate, quartz substrate or plastic substrate, and the second substrate 14 can be a thin film transistor (TFT) substrate, and the second substrate 14 can control the display of the displaying region 24, but the embodiment is not limited to this. The first substrate 12 and the second substrate 14 should be known by one skilled in the art, and will therefore not be described here. In addition, the liquid crystal layer 16 is disposed between the first substrate 12 and the second substrate 14. The surface 20 of the first substrate 12 further defines a plurality of sub-pixels 28 arranged as a matrix formation, and the sub-pixels respectively correspond to each displaying region 24.

In addition, as shown in FIG. 1, the touch device 18 is fabricated on the surface 20 of the first substrate 12, and the touch device 18 includes a patterned sensing electrode structure 30, a first insulating layer 32 and a patterned common electrode layer 34. The first insulating layer 32 covers the surface 20 of the first substrate 12 and the patterned sensing electrode structure 30, and the patterned common electrode layer 34 is disposed on the first insulating layer 32. Furthermore, as shown in FIG. 2, the patterned common electrode layer 34 includes a plurality of electrode portions 36 corresponding to the displaying regions 24 and a plurality of connecting portions 38. The connecting portions 38 are respectively disposed between the adjacent electrode portions and over the light-shielding region 26, and the connecting portions 38 are electrically connected to the electrode portions 36. In this embodiment, the patterned common electrode layer 34 includes a meshed pattern or a plurality of strip-shaped patterns parallel to each other, and the meshed pattern or the strip-shaped patterns are composed of the electrode portions 36 and the connecting portions 38. A width of each connecting portion 38 is smaller than a width of each electrode portion 36. In the present invention, the connecting portions 38 also can connect the adjacent electrode portions 36 only disposed in a first horizontal direction 40 or only disposed in a second horizontal direction 42, and the first horizontal direction 40, such as the X direction, is substantially perpendicular to the second horizontal direction 42, such as the Y direction. In addition, the patterned common electrode layer 34 can be composed of a transparent conductive material, such as indium-tin oxide (ITO) or indium-zinc oxide (IZO), but the embodiment is not limited to these materials.

As shown in FIG. 1, the touch device 18 can further include a color filter layer 44, a patterned black matrix layer 46, a third insulating layer 48 and a plurality of spacers 50. The color filter layer 44 is disposed on the first insulating layer 32, and the color filter layer 44 includes a plurality of red color filters, a plurality of green color filters and a plurality of blue color filters. Each red color filter, each green color filter and each blue color filter respectively correspond to each sub-pixel 28, and three colors can form a pixel. The patterned black matrix layer 46 is disposed on the color filter layer 44, and the patterned black matrix layer 46 exposes the displaying region 24. The patterned black matrix layer 46 can be composed of light-shielding materials, such as metal or black resin. The third insulating layer 48 covers the patterned black matrix layer 46 and the color filter layer 44, and the third insulating layer 48 is disposed between the patterned common electrode layer 34 and the patterned black matrix layer 46 and between the patterned common electrode layer 34 and the color filter layer 44, so that the third insulating layer 48 can be an overcoat. The spacer 50 is disposed on the third insulating layer 48 and disposed between the patterned common electrodes 34.

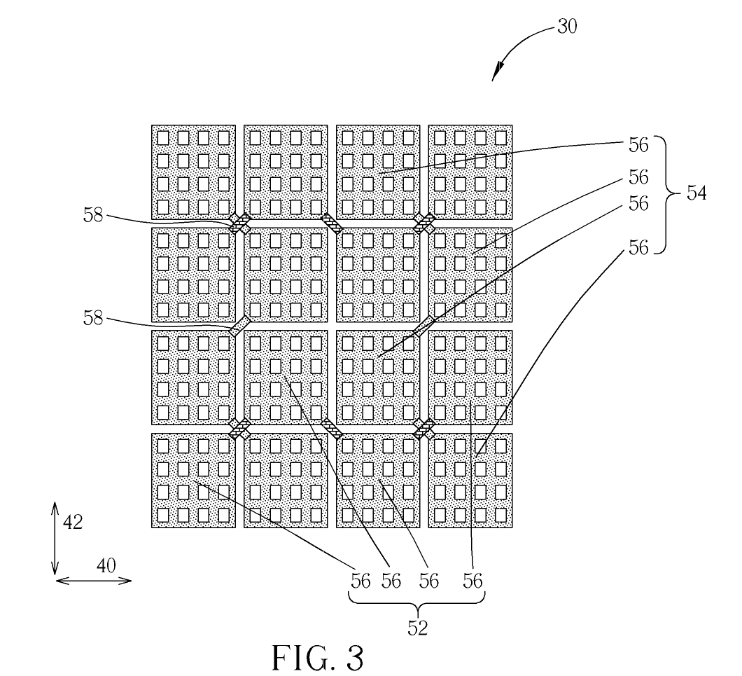

In addition, as shown in FIG. 1, the patterned sensing electrode structure 30 is disposed on the surface of the first substrate 20. The patterned sensing electrode structure 30 corresponds to the light-shielding region 26, and exposes the displaying region 24. For clearly describing the pattern of the patterned sensing electrode structure 30, please refer to FIG. 3, which is a schematic diagram illustrating a top-view of the patterned sensing electrode structure of the present invention. As shown in FIG. 3, the patterned sensing electrode structure 30 of this embodiment includes a plurality of first sensing series 52, such as X sensing series, and a plurality of second sensing series 54, such as Y sensing series, and each first sensing series 52 and each second sensing series 54 respectively have a plurality of sensing pads 56 and a plurality of bridge lines 58. The bridge lines 58 of each second sensing series 54 electrically connect the sensing pads 56 in the same second sensing series 54 along the first horizontal direction 40, and the bridge lines 58 of each first sensing pad 52 electrically connect the sensing pads in the same first sensing electrode 52 along the first horizontal direction 42. In this embodiment, the bridge lines 58 of the first sensing series 52 and the sensing pads 56 of the first sensing series 52 and the second sensing series 54 belong to a first metal layer, and the first metal layer is disposed on the first substrate 12. The bridge lines 58 of the second sensing series 54 belong to a second metal layer, and the second metal layer is disposed on the first substrate 12. The first metal layer is disposed on the second metal layer. In this embodiment, each sensing region 28 respectively includes one sensing pad 56, but the embodiment is not limited to this. Each sensing region 28 of the present invention can include at least one sensing pad 56 of the first sensing series 52 or the second sensing series 54. For example, the sensing region 28 includes four adjacent sensing pads 56 arranged as a matrix formation. In addition, the patterned sensing electrode structure 30 can be molybdenum (Mo), aluminum (Al), chromium (Cr) or an alloy thereof, such as an alloy of Mo and Al or other conductive materials, but the embodiment is not limited to this.

Referring to FIG. 1 again, it should be noted that the touch device 18 further includes a patterned anti-reflective layer 60, which has the same pattern as the patterned sensing electrode structure 30, and the patterned anti-reflective layer 60 is disposed between the patterned sensing electrode structure 30 and the first substrate 12. The patterned anti-reflective layer 60 can be composed of anti-reflective materials, such as metal oxide, so as to efficiently avoid generating a glare and dazzling effect while illuminating the patterned sensing electrode structure 30.

Referring to the structure of the touch display panel 10 of the above-mentioned embodiment, when the touch input unit 62, such as a finger, touches the surface in the sensing region 28 of the touch display panel 10 from the outside, the sensing pad 56 in the sensing region 28 generates a sensing signal, so that a position of the sensing region 28 can be determined. In addition, the electrode portions 36 of the patterned common electrode layer 34 in this embodiment corresponds to the displaying region 24, and the patterned sensing electrode structure 30 corresponds to the light-shielding region 26, so that the overlap between the patterned common electrode layer 34 and the patterned sensing electrode structure 30 can be reduced so as to help reduce the coupling capacitance between the patterned common electrode layer 34 and the patterned sensing electrode structure 30. The intensity of the generated sensing signal can therefore be increased, and the sensing signal generated from the sensing pad 56 can be prevented from being affected by the coupling capacitor between the patterned common electrode layer 34 and the patterned sensing electrode structure 30.

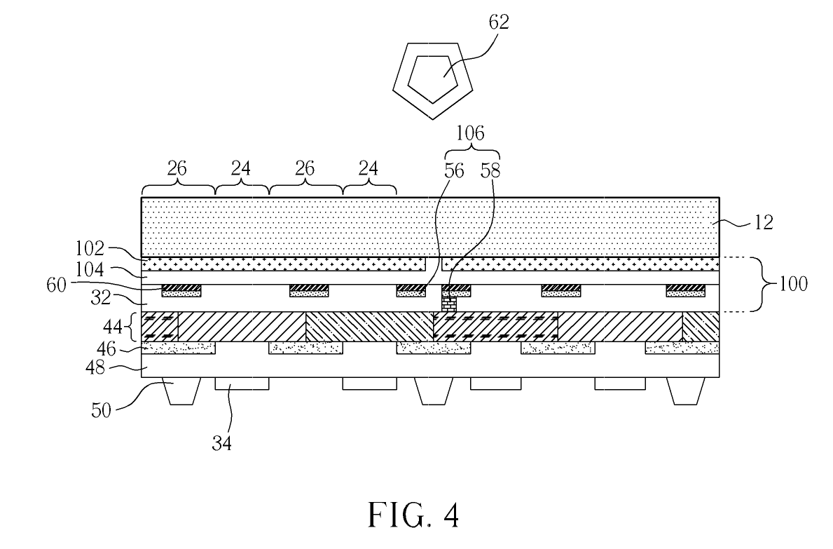

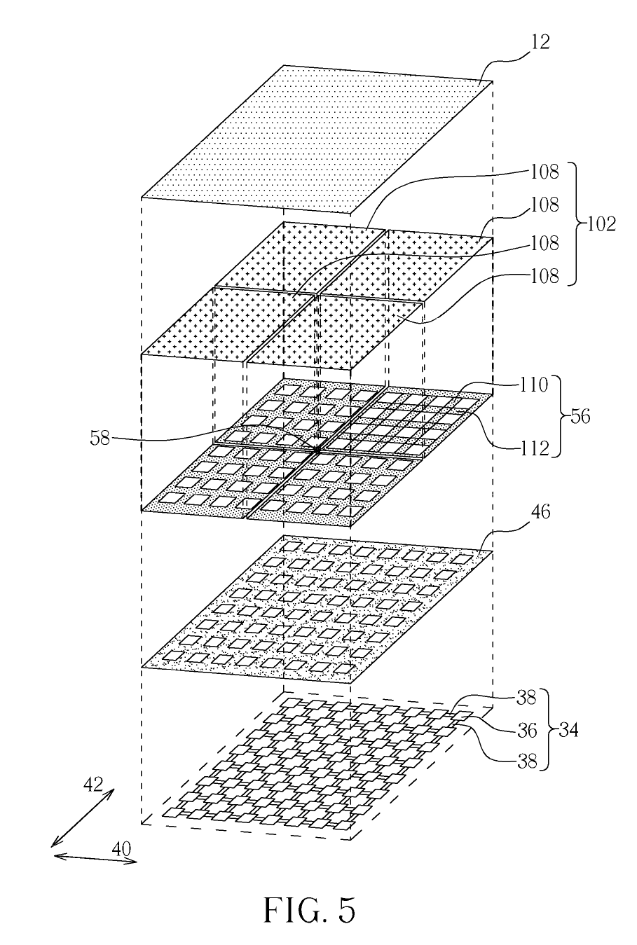

Besides the above-mentioned first preferred embodiment, the present invention has other embodiments, which are described in the following. In order to compare the difference between the embodiments, devices in the second preferred embodiment which are the same as the first preferred embodiment are assigned the same labels, and same devices will therefore not be described again. Please refer to FIG. 4 and FIG. 5. FIG. 4 is a schematic diagram illustrating a cross-sectional structure of a touch device according to a second preferred embodiment of the present invention. FIG. 5 is a schematic diagram illustrating the touch device according to the second preferred embodiment of the present invention. As shown in FIG. 4 and compared with the first preferred embodiment, the touch device 100 of this embodiment further includes a patterned transparent floating electrode layer 102 and a first insulating layer 104. The patterned transparent floating electrode layer 102 is disposed between the first substrate 12 and the patterned sensing electrode structure 106, and the second insulating layer 104 is disposed between the patterned transparent floating electrode layer 102 and the patterned sensing electrode structure 106. It should be noted that the patterned transparent floating electrode layer 102 is not electrically connected to any other power source, which means that the patterned transparent floating electrode layer 102 is in a floating state. In addition, the patterned transparent floating electrode layer 102 can be composed of transparent conductive materials, such as ITO or IZO, but the embodiment is not limited to this. Furthermore, as shown in FIG. 5, the patterned transparent floating electrode layer 102 includes a plurality of electrode sections 108, respectively corresponding to at least one sensing pad 56. In this embodiment, each electrode section 108 corresponds to the sensing pad 56 in a first sensing series or in a second sensing series. Each electrode section 108 of the present invention is not limited to correspond to only one sensing pad. In another embodiment, each electrode section 108 can correspond to two adjacent sensing pads in one of the first sensing series. In another embodiment, each electrode section 108 can correspond to two adjacent sensing pads in one of the second sensing series. In a further embodiment, each electrode section 108 also can correspond to four adjacent sensing pads arranged as a matrix formation. Two of the four adjacent sensing pads are disposed in one of the first sensing series, and the other two of the four adjacent sensing pads are disposed in one of the second sensing series.

Furthermore, it should be noted that another difference between this embodiment and the first preferred embodiment is that the patterned sensing electrode structure 106 of this embodiment includes a plurality of second horizontal line portions 110 disposed along the second horizontal direction 42, and a plurality of first horizontal line portions 112 disposed along the first horizontal direction 40 and perpendicular to the second horizontal line portions 110. The first horizontal line portions 112 and the second horizontal line portions 110 respectively correspond to a portion of the patterned black matrix layer 46. A width of each of the first horizontal line portions 112 and the second horizontal line portions 110 can be smaller than a width of the corresponding portion of the patterned black matrix layer 46.

This embodiment disposes the patterned transparent floating electrode layer 102 between the sensing electrode structure 106 and the first substrate 12, and increases the area of the patterned transparent floating electrode layer 102 to raise the sensing capacitance between the touch input unit 62 and the patterned sensing electrode structure 106. Therefore, the intensity of the sensing signal sensed from the patterned sensing electrode structure 106 can be increased. In addition, this embodiment also reduces the width of the second horizontal line portions 110 and the first horizontal line portions 112 of the patterned sensing electrode structure 106 to increase the distance and the overlap between the patterned sensing electrode structure 106 and the patterned common electrode layer 34. Therefore, the coupling capacitance between the patterned sensing electrode structure 106 and the patterned common electrode layer 34 can be reduced, and the sensing signal generated from the patterned sensing electrode structure 106 can be prevented from being reduced by the coupling capacitor.

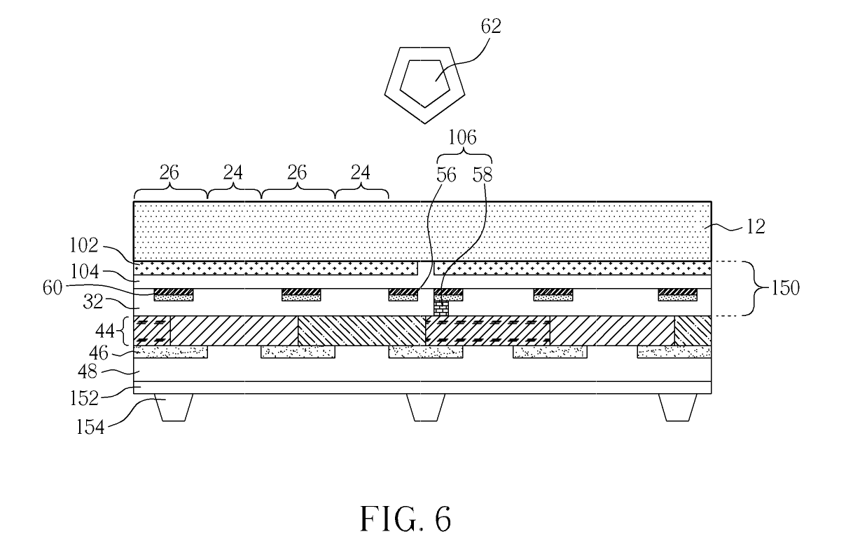

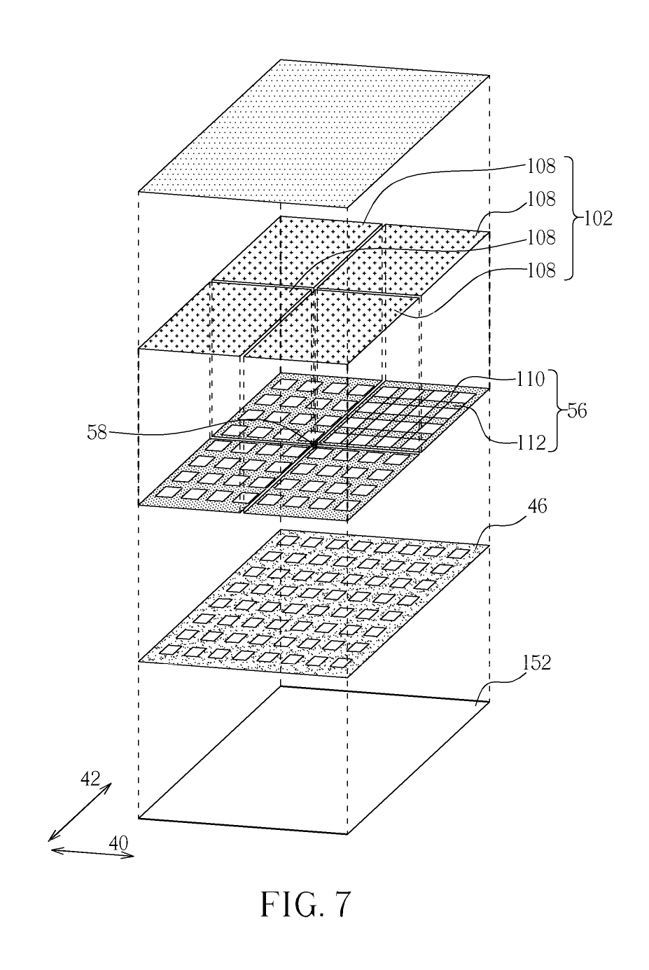

Please refer to FIG. 6 and FIG. 7. FIG. 6 is a schematic diagram illustrating a cross-sectional structure of a touch device according to a third preferred embodiment of the present invention. FIG. 7 is a schematic diagram illustrating the touch device according to the third preferred embodiment of the present invention. In order to compare the difference between the embodiments, devices in the third preferred embodiment that are the same as the second preferred embodiment are assigned the same labels, and the same devices will not be described again. As shown in FIG. 6 and FIG. 7 and compared with the second embodiment, a common electrode layer 152 in the touch device 150 of this embodiment does not have a patterned structure. The common electrode layer 152 covers the third insulating layer 48, and the common electrode layer 152 is substantially flat. In addition, the spacer 154 of this embodiment is disposed on the common electrode layer 152 and in the light-shielding region 26.

As mentioned above, the present invention provides the patterned sensing electrode structure combined with the mesh structure of the patterned common electrode layer, and reduces the width of the patterned sensing electrode structure of the touch device so as to reduce the overlap or the distance between the patterned sensing electrode structure and the patterned common electrode layer. Therefore, the coupling capacitance between the patterned sensing electrode structure and the patterned common electrode layer can be reduced. Accordingly, the sensing signal generated from the patterned sensing electrode structure can be prevented from being reduced by the coupling capacitor. In addition, the present invention further provides the patterned transparent floating electrode layer to increase the sensing capacitance between the touch input unit and the patterned sensing electrode structure, so that the intensity of the sensing signal sensed from the patterned sensing electrode structure can be increased.

Those skilled in the art will readily observe that numerous modifications and alterations of the device and method may be made while retaining the teachings of the invention.

What is claimed is:

1. A touch device, formed on a surface of a substrate, the surface of the substrate defining a plurality of sensing regions arranged as a matrix formation, and each sensing region defining a plurality of displaying regions arranged as a matrix formation and a light-shielding region disposed between the displaying regions, the touch device comprising:
a patterned sensing electrode structure, disposed on the surface of the substrate, the patterned sensing electrode structure corresponding to the light-shielding region and exposing the displaying regions;
a first insulating layer, covering the substrate and the patterned sensing electrode structure; and
a patterned common electrode layer, disposed on the first insulating layer, the patterned common electrode layer comprising a plurality of electrode portions corresponding to the displaying regions and a plurality of connecting portions, the connecting portions being disposed between the adjacent electrode portions and over the light-shielding region, and the connecting portions being electrically connected to the electrode portions.

2. The touch device of claim 1, wherein the patterned sensing electrode structure comprises a plurality of first sensing series and a plurality of second sensing series perpendicular to the first sensing series.

3. The touch device of claim 2, wherein each first sensing series and each second sensing series have a plurality of sensing pads and a plurality of bridge lines.

4. The touch device of claim 3, further comprising a patterned transparent floating-electrode layer, disposed between the substrate and the patterned sensing electrode structure.

5. The touch device of claim 4, further comprising a second insulating layer, disposed between the patterned transparent floating-electrode layer and the patterned sensing electrode structure.

6. The touch device of claim 5, wherein the patterned transparent floating-electrode layer comprises a plurality of electrode sections, respectively corresponding to at least one of the sensing pads.

7. The touch device of claim 1, wherein the patterned common electrode layer comprises a meshed pattern, composed of the electrode portions and the connecting portions.

8. The touch device of claim 1, further comprising a patterned anti-reflective layer, disposed between the patterned sensing electrode structure and the substrate, the patterned anti-reflective layer having a same pattern as the patterned sensing electrode structure.

9. The touch device of claim 1, further comprising:
a color filter layer, disposed on the first insulating layer;
a patterned black matrix layer, disposed on the color filter layer, the patterned black matrix layer exposing the displaying regions; and
a third insulating layer, covering the patterned black matrix layer and the color filter layer.

10. The touch device of claim 9, wherein a width of the patterned sensing electrode structure is smaller than a width of the corresponding patterned black matrix layer.

11. A touch display panel, comprising:
a first substrate and a second substrate, being parallel to each other, the first substrate having a surface facing the second substrate, the surface of the first substrate defining a plurality of sensing regions, and each sensing region defining a plurality of displaying regions arranged as a matrix formation and a light-shielding region disposed between the displaying regions;
a liquid crystal layer, disposed between the first substrate and the second substrate;
a patterned sensing electrode structure, disposed on the surface of the first substrate, and the patterned sensing electrode structure corresponding to the light-shielding region and exposing the displaying regions;
a first insulating layer, covering the surface of the first substrate and the patterned sensing electrode structure; and
a patterned common electrode layer, disposed on the first insulating layer, the patterned common electrode layer comprising a plurality of electrode portions corresponding to the displaying regions and a plurality of connecting portions, the connecting portions being disposed between the adjacent electrode portions and electrically connected to the electrode portions.

12. The touch display panel of claim 11, wherein the patterned sensing electrode structure comprises a plurality of first sensing series and a plurality of second sensing series perpendicular to the first sensing series.

13. The touch display panel of claim 12, wherein each first sensing series and each second sensing series have a plurality of sensing pads and a plurality of bridge lines.

14. The touch display panel of claim 13, further comprising a patterned transparent floating-electrode layer, disposed between the first substrate and the patterned sensing electrode structure.

15. The touch display panel of claim 14, further comprising a second insulating layer disposed between the patterned transparent floating-electrode layer and the patterned sensing electrode structure.

16. The touch display panel of claim 15, wherein the patterned transparent floating-electrode layer comprises a plurality of electrode sections, respectively corresponding to at least one of the sensing pads.

17. The touch display panel of claim 11, wherein the patterned common electrode layer comprises a meshed pattern, composed of the electrode portions and the connecting portions.

18. The touch display panel of claim 11, further comprising a patterned anti-reflective layer, disposed between the patterned sensing electrode structure and the first substrate, the patterned anti-reflective layer having a same pattern as the patterned sensing electrode structure.

19. The touch display panel of claim 11, further comprising:
a color filter layer, disposed on the first insulating layer;
a patterned black matrix layer, disposed on the color filter layer, the patterned black matrix layer exposing the displaying regions; and
a third insulating layer, covering the patterned black matrix layer and the color filter layer.

20. The touch display panel of claim 19, wherein a width of the patterned sensing electrode structure is smaller than a width of the corresponding patterned black matrix layer.

21. The touch display panel of claim 11, wherein the surface of the first substrate further defines a plurality of sub-pixels arranged as a matrix formation, respectively corresponding to each displaying region.
